(19) United States
(12) Patent Application Publication
(10) Pub. No.: US 2016/0188959 A1
(43) Pub. Date: Jun. 30, 2016

(54) Image Capture Apparatus Capable of Processing Photographed Images

(71) Applicant: CASIO COMPUTER CO., LTD, Shibuya-ku (JP)

(72) Inventor: Tsuyoshi Matsunaga, Hamura-shi (JP)

(73) Assignee: CASIO COMPUTER CO., LTD, Tokyo (JP)

(21) Appl. No.: 14/940,394

(22) Filed: Nov. 13, 2015

(30) Foreign Application Priority Data
Dec. 29, 2014 (JP) 2014-267014

(51) Int. Cl. G06K 9/00; G06T 7/00; G06K 9/52; G06K 9/62; G06T 7/40; G06K 9/46

(52) U.S. Cl. CPC G06K 9/00281; G06T 7/408; G06K 9/4652; G06K 9/00288; G06K 9/52; G06K 9/6201; G06T 7/0042; G06T 2207/30201; G06K 2009/4666

(57) ABSTRACT

In an image capture apparatus comprising an image capture unit including an image sensor and a control unit including a CPU, the control unit detects a facial portion of a person within an image captured by the image capture unit and performs image processing unique to a person on the facial portion, and, in a case in which it is possible to estimate that a person is a target for photographing in a method different from a detection of a face of the person, the control unit controls to perform the image processing unique to a person on a skin color portion detected within the image.

This application is based on and claims the benefit of priority from Japanese Patent Application No. 2014-267014, filed on 29 Dec. 2014, the content of which is incorporated herein by reference.

### BACKGROUND OF THE INVENTION

1. Field of the Invention

The present invention relates to an image capture apparatus capable of processing photographed images, an image capture control method, and a storage medium storing a program.

2. Related Art

Technologies have been known that relate to cameras (image capture apparatus) having a face beautification function which performs image processing in order to put on skin beautification/skin whitening on a facial part of a person detected within a photographed image (refer to Japanese Unexamined Patent Application, Publication No. 2011-55066 and Japanese Unexamined Patent Application, Publication No. 2014-96836).

### SUMMARY OF THE INVENTION

An aspect of the present invention is an image capture apparatus comprising an image capture unit including an image sensor and a control unit including a CPU, in which the control unit detects a facial portion of a person within an image captured by the image capture unit and performs image processing unique to a person on the facial portion, and, in a case in which it is possible to estimate that a person is a target for photographing by a method different from detection of a face of the person, the control unit controls to perform the image processing unique to a person on a skin color portion detected within the image.

Furthermore, another aspect of the present invention is an image capture apparatus comprising an image capture unit including an image sensor and a control unit including a CPU, in which the control unit detects a subject using characteristic information of a first viewpoint relating to a subject of a specific kind within an image captured by the image capture unit and performs image processing unique to the subject on a subject portion detected, and, in a case in which it is possible to estimate that the subject of the specific kind is a target for photographing using other information different from characteristic information relating to the subject of the specific kind, the control unit controls so as to perform image processing unique to the subject of the specific kind on an image region detected using characteristic information of a second viewpoint relating to the subject of the specific kind.

Furthermore, yet another aspect of the present invention is an image capture control method executed by an image capture apparatus including an image capture unit, the method including: detecting a subject using characteristic information of a first viewpoint relating to a subject of a specific kind within an image captured by the image capture unit, and performing image processing unique to the subject on a subject portion detected; and controlling, in a case in which it is possible to estimate that the subject of the specific kind is a target for photographing using other information different from characteristic information relating to the subject of the specific kind, so as to perform image processing unique to the subject of the specific kind on an image region detected using characteristic information of a second viewpoint relating to the subject of the specific kind.

Furthermore, another aspect of the present invention is a non-transitory storage medium encoded with a computer-readable program that enables a computer which controls an image capture apparatus including an image capture unit to execute functions of: detecting a subject using characteristic information of a first viewpoint relating to a subject of a specific kind within an image captured by the image capture unit and performs image processing unique to the subject on a subject portion detected; and controlling, in a case in which it is possible to estimate that the subject of the specific kind is a target for photographing using other information different from characteristic information relating to the subject of the specific kind, so as to perform image processing unique to the subject of the specific kind on an image region detected using characteristic information of a second viewpoint relating to the subject of the specific kind.

### BRIEF DESCRIPTION OF THE DRAWINGS

FIG. 1 is a block diagram showing a hardware configuration of an image capture apparatus according to one embodiment of the present invention;

FIG. 2 is a functional block diagram showing a functional configuration for executing photographing processing among the functional configurations of the image capture apparatus of FIG. 1;

FIG. 3 is a flowchart illustrating a flow of photographing processing executed by the image capture apparatus of FIG. 1 having the functional configuration of FIG. 2; and

FIG. 4 is a flowchart explaining a flow of photographing processing executed by the image capture apparatus of FIG. 1 having the functional configuration of FIG. 2 in a second embodiment.

### DETAILED DESCRIPTION OF THE INVENTION

Embodiments of the present invention are explained below with reference to the drawings.

### First Embodiment

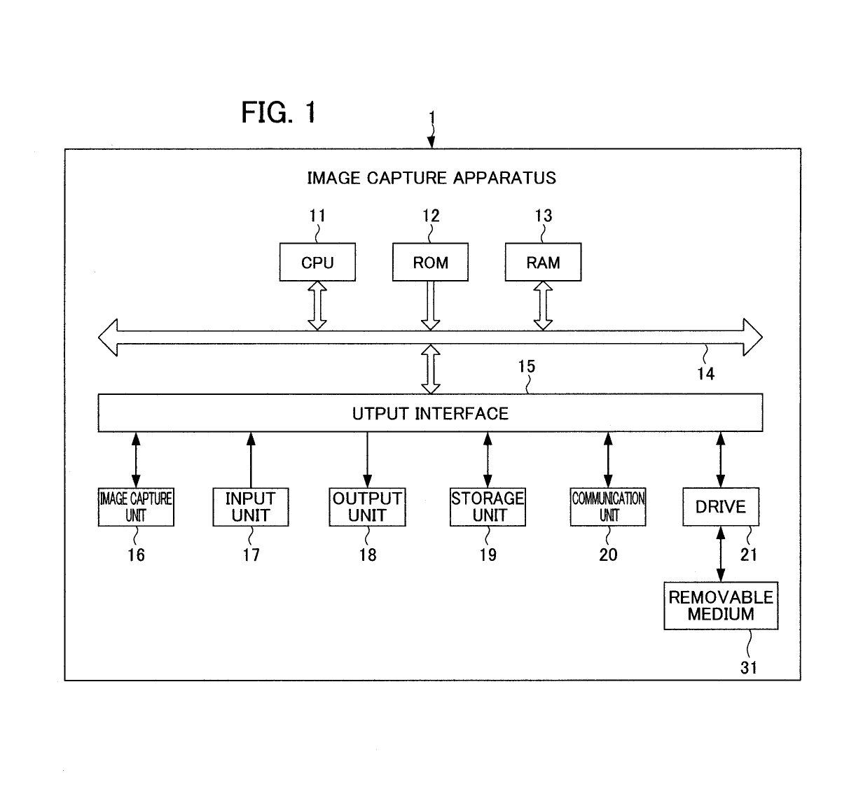

FIG. 1 is a block diagram showing the hardware configuration of an image capture apparatus according to an embodiment of the present invention.

The image capture apparatus 1 is configured as, for example, a digital camera.

The image capture apparatus 1 includes a CPU (Central Processing Unit) 11, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12, and the RAM 13 constitute a control unit.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor, which are not shown.

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, an image processing unit (not illustrated), and the like as appropriate.

The input unit 17 is configured by various buttons and the like, and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

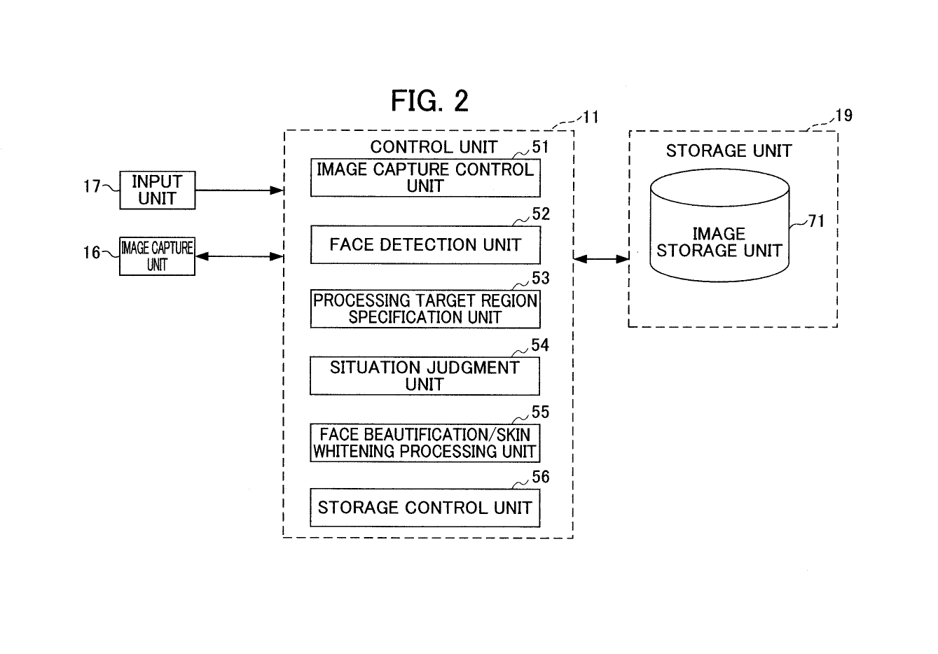

FIG. 2 is a functional block diagram showing a functional configuration for executing photographing processing among the functional configurations of such an image capture apparatus 1.

Photographing processing refers to a sequence of processing of imparting a skin beautification/skin whitening effect to the face of a person in a captured image by executing the skin beautification/skin whitening processing after executing image capture processing.

In a case of executing the photographing processing, as shown in FIG. 2, an image capture control unit 51, a face detection unit 52, a processing target region specification unit 53, a situation judgment unit 54, a face beautification/skin whitening processing unit 55, and a storage control unit 56 function in a control unit (CPU 11, ROM 12, RAM 13).

Furthermore, an image storage unit 71 is provided in a region of the storage unit 19.

Data of a captured image is stored in the image storage unit 71.

The image capture control unit 51 controls the image capture unit 16 to perform image capturing. As a result, a captured image is outputted from the image capture unit 16.

The face detection unit 52 detects whether the face of a person is included in a photographed range in a captured image acquired from the image capture unit 16 by way of image analysis. The face detection unit 52 executes, as face detection, image processing to adjust a photographing condition to a person with an image region corresponding to person as a target, i.e. image processing to adjust a focus to a distance to a person or image processing to adjust an exposure condition to the brightness of a person.

The processing target region specification unit 53 specifies a region (hereinafter, referred to as “processing target region”) as a processing target on which skin beautification/skin whitening processing is performed in a captured image thus acquired.

The situation judgment unit 54 judges whether or not being a situation in which the face of a person should be included in a photographed range by a method other than analysis of a photographed image. The situation in which the face of a person should be included refers to a situation in which the probability of the face of a person being included in a captured image is high, and such a situation is judged based on a condition of the image capture apparatus 1 and the environment surrounding the image capture apparatus 1. The situation in which the face of a person should be included is, for example, a case of selecting a selfie mode (a mode of photographing oneself).

More specifically, the situation judgment unit 54 judges whether a selfie mode is set, for example, as the situation in which the face of a person should be included in a photographed range. In a case in which the selfie mode is set, the situation judgment unit 54 judges that a situation is the situation in which the face of a person should be included in a photographed range, and in a case in which the selfie mode is not set, the situation judgement unit 54 judges as not being the situation in which the face of a person should be included in a photographed range.

The skin beautification/skin whitening processing unit 55 performs skin beautification/skin whitening processing on a processing target region specified by the processing target region specification unit 53. The skin beautification/skin whitening processing refers to processing to perform processing so that skin looks beautiful or skin turns white in a beautiful fashion, and employs an existing, well-known image processing technology relating to skin beautification/skin whitening.

The storage control unit 56 controls the image storage unit 71 to store a captured image.

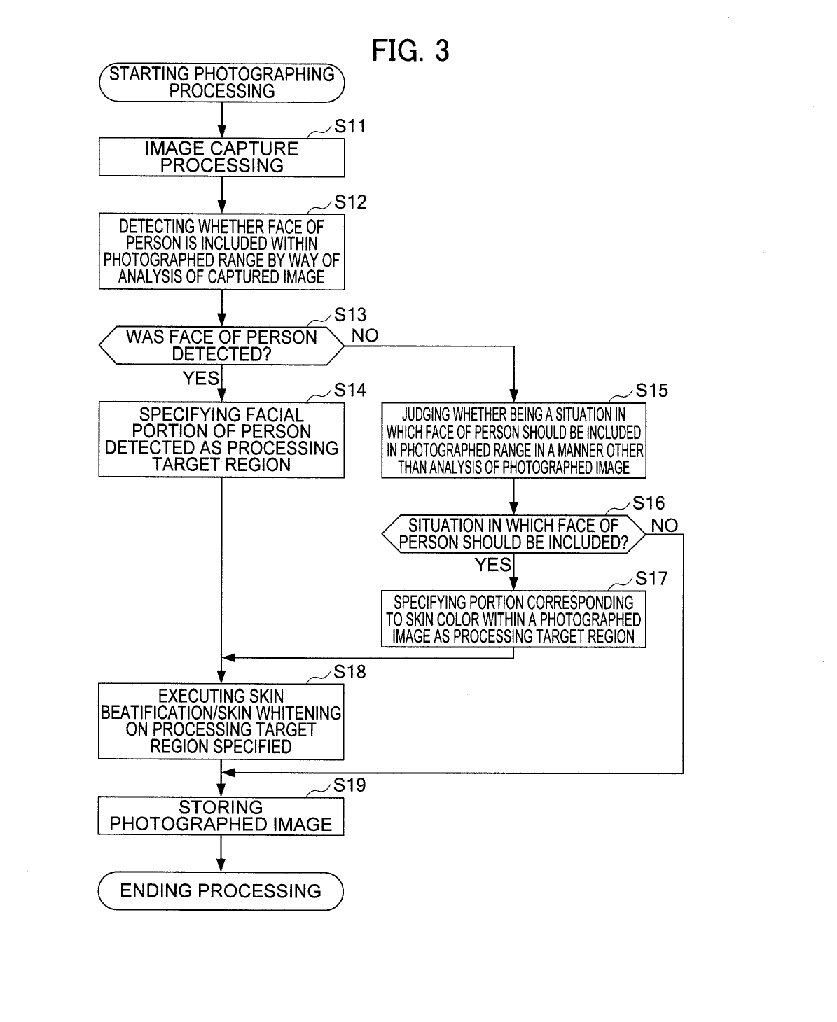

FIG. 3 is a flowchart illustrating a flow of photographing processing executed by the image capture apparatus 1 of FIG. 1 having the functional configuration of FIG. 2.

The photographing processing starts by a user's operation of starting the photographing processing to the input unit 17.

In Step S11, the image capture control unit 51 performs image capture processing. The image capture control unit 51 controls the image capture unit 16 to perform image capturing. As a result of the image capture processing, a captured image is outputted from the image capture unit 16.

In Step S12, the face detection unit 52 detects whether the face of a person is included in a photographed range by way of analysis of a photographed image.

In Step S13, the face detection unit 52 judges whether the face of a person was detected.

In a case of the face of a person being detected, it is judged as YES in Step S13 and the processing advances to Step S14.

In a case of the face of a person not being detected, it is judged as NO in Step S13 and the processing advances to Step S15.

In Step S14, the processing target region specification unit 53 specifies a facial portion of a person thus detected as a processing target region.

In Step S15, the situation judgment unit 54 judges whether being a situation in which the face of a person should be included in a photographed range in a method other than an analysis of a photographed image. The situation judgment unit 54 judges whether a selfie mode has been set, for example, as the situation in which the face of a person should be included in a photographed range. In a case in which the selfie mode has been set, the situation judgment unit 54 judges as being a situation in which the face of a person should be included in a photographed range, and in a case in which the selfie mode has not been set, the situation judgment unit 54 judges as not being a situation in which the face of a person should be included in a photographed range.

In Step S16, the situation judgment unit 54 judges whether being a situation in which the face of a person should be included.

In a case of being a situation in which the face of a person should be included, it is judged as YES in Step S16 and the processing advances to Step S17.

In a case of not being a situation in which the face of a person should be included, it is judged as NO in Step S16 and the processing advances to Step S19.

In Step S17, the processing target region specification unit 53 specifies a portion corresponding to skin color within a photographed image as a processing target region.

In Step S18, the skin beautification/skin whitening processing unit 55 executes skin beautification/skin whitening processing on the processing target region thus specified.

In Step S19, the storage control unit 56 causes the image storage unit 71 to store a photographed image.

Then, the photographing processing ends.

It should be noted that, in the abovementioned embodiment, it may be configured so as to execute the skin beautification/skin whitening processing only in a case of the face of a person being detected and of the situation in which the face of a person should be included.

Furthermore, in the abovementioned embodiment, it may also be configured so as to execute the skin beautification/skin whitening processing by preferentially judging whether being a situation in which the face of a person should be included more than the detection of the face of a person.

### Second Embodiment

In the abovementioned embodiment, it is configured so as to execute the skin beautification/skin whitening processing on a facial portion in a case of the face of a person being detected, and to execute the skin beautification/skin whitening processing on a skin color portion even in a case of the face of a person not having been detected so long as being a situation in which the face of a person should be included. On the other hand, in the present embodiment, it is configured so as to selectively switch a photographing mode which executes the skin beautification/skin whitening processing to a facial portion in a case of the face of a person having been detected (hereinafter, referred to as “normal photographing mode”) and a photographing mode which executes the skin beautification/skin whitening on a skin color portion in a case of being the situation in which the face of a person should be included (hereinafter, referred to as “face-undetected judgment mode”). In other words, in the present embodiment, it is configured so as to judge by a method other than image analysis of a photographed image in the face-undetected judgment mode.

It should be noted that, in the second embodiment, descriptions for the matters in common with the first embodiment are omitted. In other words, in the second embodiment, since the hardware configuration and the functional configuration in the image capture apparatus 1 are the same, descriptions thereof are omitted.

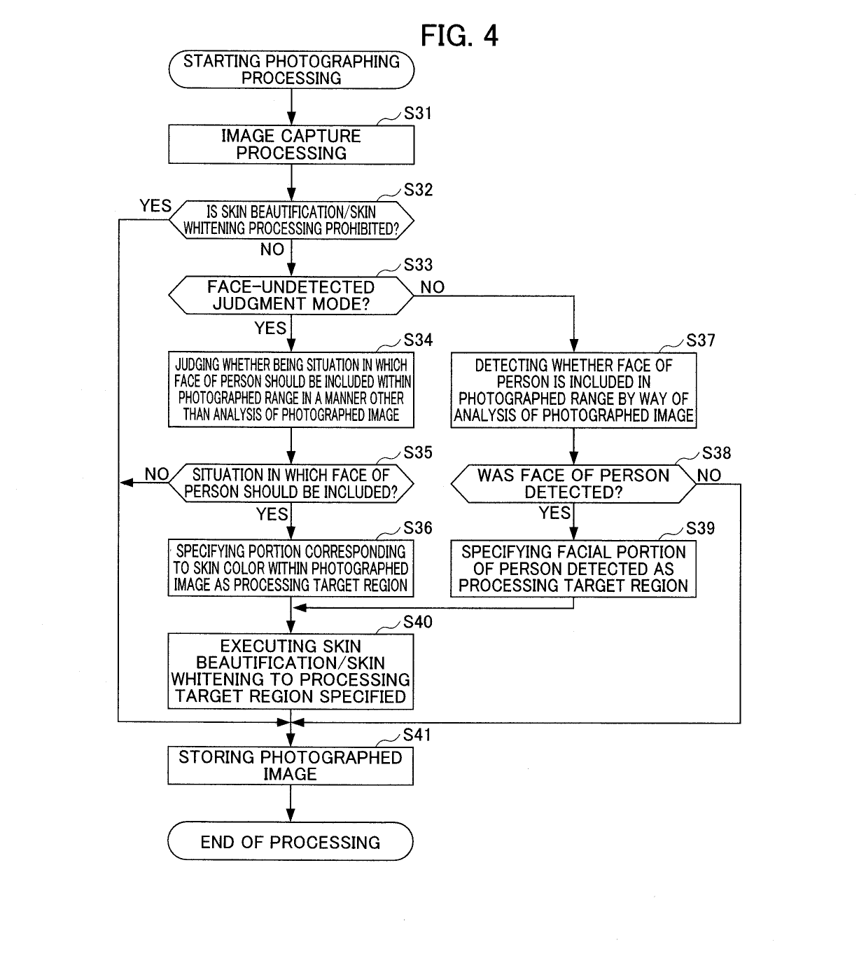

FIG. 4 is a flowchart illustrating a flow of photographing processing executed by the image capture apparatus 1 of FIG. 1 having the functional configuration of FIG. 2 in the second embodiment.

The photographing processing starts by a user's operation of starting the photographing processing to the input unit 17.

In Step S31, the image capture control unit 51 performs image capture processing. The image capture control unit 51 controls the image capture unit 16 to perform image capturing. As a result of the image capture processing, a captured image is outputted from the image capture unit 16.

In Step S32, the image capture control unit 51 judges whether the skin beautification/skin whitening processing is prohibited.

In the case of the skin beautification/skin whitening being prohibited, it is judged as YES in Step S32 and the processing advances to Step S41.

In the case of the skin beautification/skin whitening not being prohibited, it is judged as NO in Step S32 and the processing advances to Step S33.

In Step S33, the image capture control unit 51 judges whether being in the face-undetected judgment mode.

In the case of being in the face-undetected judgment mode, it is judged as YES in Step S33 and the processing advances to Step S34.

In the case of not being the face-undetected judgment mode, it is judged as NO in Step S33 and the processing advances to Step S37.

In Step S34, the situation judgment unit 54 judges whether being a situation in which the face of a person should be included in a photographing range by a method other than analysis of a photographed image. The situation judgment unit 54 judges whether a selfie mode is set, for example, as the situation in which the face of a person should be included in a photographed range. In a case in which the selfie mode is set, the situation judgment unit 54 judges as being situation in which the face of a person should be included in a photographed range, and in a case in which the selfie mode is not set, the situation judgement unit 54 judges as not being a situation in which the face of a person should be included in a photographed range.

In Step S35, the situation judgment unit 54 judges whether it is a situation in which the face of a person should be included.

In a case of being the situation in which the face of a person should be included, it is judged as YES in Step S35 and the processing advances to Step S36.

In a case of not being the situation in which the face of a person should be included, it is judged as NO in Step S35 and the processing advances to Step S41.

In Step S36, the processing target region specification unit 53 specifies a portion corresponding to skin color within a photographed image as a processing target region.

In Step S37, the face detection unit 52 detects whether the face of a person is included within a photographed range by way of analysis of a photographed image.

In Step S38, the face detection unit 52 judges whether the face of a person has been detected.

In a case of the face of a person having been detected, it is judged as YES in Step S38 and the processing advances to Step S39.

In a case of the face of a person not having been detected, it is judged as NO in Step S38 and the processing advances to Step S41.

In Step S39, the processing target region specification unit 53 specifies a facial portion of a person thus detected as a processing target region.

In Step S40, the skin beautification/skin whitening processing unit 55 executes the skin beautification/skin whitening on the processing target region thus specified.

In Step S41, the storage control unit 56 causes the image storage unit 71 to store a photographed image.

Then, the photographing processing ends.

Therefore, in a conventional image capture apparatus having a feature of executing skin beautification/skin whitening processing, since the skin beautification/skin whitening processing is skipped in a case in which a face cannot be detected, the skin beautification/skin whitening processing may or may not be performed depending on the performance of the face detection. However, according to the present invention, it is possible to store (photograph) a captured image on which the skin beautification, skin whitening processing, etc., has been conducted on skin reliably since the skin beautification, skin whitening processing, etc., on skin is implemented even in a case in which a face could not be detected, including a case in which a face detection tends to fail due to a pair of glasses or hair covering eyes, for example.

The image capture apparatus 1 configured as above includes the image capture unit 16, the face detection unit 52, the processing target region specification unit 53, and the skin beautification/skin whitening processing unit 55.

The face detection unit 52 specifies an image region corresponding to a predetermined subject within a photographed image captured by the image capture unit 16 using characteristic information of a first viewpoint relating to the subject.

The processing target region specification unit 53 specifies an image region within a photographed image using characteristic information of a second viewpoint which is different from the first viewpoint relating to a predetermined subject.

The skin beautification/skin whitening processing unit 55 executes image processing unique to a predetermined subject with an image region corresponding to a predetermined subject as a target.

Furthermore, in a case in which the image processing is first image processing unique to a predetermined subject, the skin beautification/skin whitening processing unit 55 executes image processing with an image region specified by the processing target region specification unit 53 as a target.

With such a configuration, in the image capture apparatus 1, in a case in which image processing is the first image processing unique to a predetermined subject, since the image processing is executed with the image region specified by the processing target region specification unit 53 as a target, it is possible to efficiently control execution of the image processing unique to a subject on a subject within a photographed image.

Furthermore, the image capture apparatus 1 includes the face detection unit 52 that specifies using the characteristic information of the first viewpoint.

In a case in which the image region corresponding to a predetermined subject could not be specified by the face detection unit 52, the skin beautification/skin whitening processing unit 55 executes the first image processing in the image processing means with the image region specified by the processing target region specification unit 53 as a target.

With such a configuration, in the image capture apparatus 1, since the image processing unique to a predetermined subject is executed with the image region specified by the processing target region specification unit 53 as a target, even in a case in which the image region corresponding to a predetermined subject could not be specified by the face detection unit 52, it is possible to efficiently control execution of the image processing unique to a subject on a subject within a photographed image.

The accuracy of the second viewpoint in specifying an image region corresponding to a predetermined subject is lower than that of the first viewpoint; however, the probability that an image region as a target for the first image processing can be specified is higher than that of the first viewpoint.

With such a configuration, in the image capture apparatus 1, it is possible to improve the accuracy of the image region and to efficiently control execution of the image processing unique to a subject on a subject within a photographed image.

Furthermore, in a case in which the image processing executed is a second image processing, the skin beautification/skin whitening processing unit 55 executes image processing as an image region specified by the face detection unit 52 as a target.

With such a configuration, in the image capture apparatus 1, it is possible to specify an image region using the face detection.

Furthermore, the image capture apparatus 1 includes the situation judgment unit 54 which judges whether being a situation in which a predetermined subject should exist within a photographed range without using characteristic information relating to a predetermined subject.

The skin beautification/skin whitening processing unit 55 executes the image processing unique to a predetermined subject with the image region specified by the face detection unit 52 as a target, in a condition in which it has been judged by the situation judgment unit 54 as being a situation in which a predetermined subject should exist within a photographed range.

With such a configuration, in the image capture apparatus 1, it is possible to efficiently control execution of the image processing unique to a subject on a subject within a photographed image.

The skin beautification/skin whitening processing unit 55 executes the first image processing with an image region specified by the face detection unit 52 as a target, in a condition in which it has been judged by the situation judgment unit 54 as not being possible to specify an image region corresponding to a predetermined subject and being a situation in which a predetermined subject should exist within a photographed range.

With such a configuration, in the image capture apparatus 1, it is possible to efficiently control execution of image processing unique to a subject on a subject within a photographed image.

The face detection unit 52 performs both judging whether a predetermined subject exists within a photographed subject and specifying an image region on which image processing unique to a predetermine subject is performed.

The processing target region specification unit 53 only performs specifying an image region on which image processing unique to a predetermined subject is executed without performing judging whether a predetermined subject exists within a photographed range.

With such a configuration, in the image capture apparatus 1, it is possible to specify an image region reliably and efficiently control execution of image processing unique to a subject on a subject within a photographed image.

In a case in which it has been judged by the situation judgment unit 54 as being a situation in which a predetermined subject should exist within a photographed range, the skin beautification/skin whitening processing unit 55 is made to execute image processing unique to a predetermined subject with the image region specified by the face detection unit 52 as a target, in a condition in which it was judged by the face detection unit 52 that a predetermined subject exists within a photographed range.

With such a configuration, in the image capture apparatus 1, it is possible to efficiently control execution of image processing unique to a subject on a subject within a photographed image.

The skin beautification/skin whitening processing unit 55 executes image processing according to a region specification result by the face detection unit 52 or the processing target region specification unit 53, and a judgment result by the situation judgment unit 54.

With such a configuration, in the image capture apparatus 1, it is possible to efficiently control execution of image processing unique to a subject on a subject within photographed image.

The skin beautification/skin whitening processing unit 55 selects either the processing target region specification unit 53 or the face detection unit 52 for specifying an image region as a target for image processing unique to a predetermined subject, according to a judgment result by the situation judgment unit 54.

With such a configuration, in the image capture apparatus 1, it is possible to efficiently control execution of image processing unique to a subject on a subject within photographed image.

Furthermore, in the image capture apparatus 1, the characteristic information of the first viewpoint is a characteristic of the form of a predetermined subject and the characteristic information of the second viewpoint is a characteristic of the color of a predetermined subject.

The face detection unit 52 specifies an image region using at least a characteristic of the form of a predetermined subject.

The processing target region specification unit 53 specifies an image region without using a characteristic of the form of a predetermined subject.

With such a configuration, in the image capture apparatus 1, it is possible to efficiently control execution of image processing unique to a subject on a subject within a photographed image reliably in order to specify an image region in a different viewpoint.

The face detection unit 52 specifies an image region using both a characteristic of the form of a predetermined subject and a characteristic of color.

The processing target region specification unit 53 specifies an image region using only a characteristic of the color of a predetermined subject.

With such a configuration, in the image capture apparatus 1, it is possible to efficiently control execution of image processing unique to a subject on a subject within a photographed image reliably.

Furthermore, in the image capture apparatus 1, the predetermined subject is a person.

The face detection unit 52 specifies an image region corresponding to the face of a person within a photographed image captured by the image capture unit 16 by way of face detection processing using characteristic information of the face of a person.

The processing target region specification unit 53 specifies an image region on which image processing unique to a person is executed without performing the face detection processing.

With such a configuration, in the image capture apparatus 1, it is possible to specify the image region corresponding to the face of a person by way of the face detection processing, and thus it is possible to efficiently control execution of image processing unique to a subject on the person within the photographed image.

The processing target region specification unit 53 judges whether being a situation in which the face of a person should exist within a photographed range without using a face detection result by way of the face detection processing.

With such a configuration, in the image capture apparatus 1, since the judgment is performed without using the face detection result by way of the face detection processing, it is possible to efficiently control execution of the image processing unique to a subject on a person within a photographed image.

The situation judgment unit 54 specifies an image region having a color corresponding to the skin color of a person as an image region on which image processing unique to a person is executed without performing the face detection processing. With such a configuration, in the image capture apparatus 1, since the image region having a color corresponding to the skin color of a person is specified as the image region on which the image processing unique to a person is executed, it is possible to efficiently control execution of the image processing unique to a subject on the skin of a person within a photographed image.

As first image processing, the skin beautification/skin whitening processing unit 55 executes image processing relating to skin beautification or skin whitening with an image region corresponding to the skin of a person as a target.

With such a configuration, in the image capture apparatus 1, it is possible to efficiently control execution of image processing on a skin color (skin beautification or skin whitening) unique to a subject on a person within a photographed image.

As second image processing, the skin beautification/skin whitening processing unit 55 executes image processing of adjusting a photographing condition to a person with an image region corresponding to person as a target.

With such a configuration, in the image capture apparatus 1, it is possible to use image processing to adjust a photographing condition to a person with an image region corresponding to a person as a target, and it is possible to efficiently control execution of image processing to the skin color (skin beautification or skin whitening) unique to a subject on a person within a photographed image.

The second image processing is image processing to adjust a focus to a distance to a person, or image processing to adjust an exposure condition to the brightness of a person.

With such a configuration, in the image capture apparatus 1, it is possible to use image processing by way of conventional face detection technology to adjust a focus to a distance to a person or image processing to adjust an exposure condition to the brightness of a person, and it is possible to efficiently control execution of image processing to a skin color (skin beautification or skin whitening) unique to a subject on a person within a photographed image.

The image capture apparatus 1 configured as above includes the image capture unit 16, the face detection unit 52, the skin beautification/skin whitening processing unit 55, and the situation judgment unit 54.

The face detection unit 52 executes region specification processing to specify an image region corresponding to a skin portion of a person within a photographed image captured by the image capture unit 16.

The skin beatification/skin whitening processing unit 55 executes image processing relating to skin beautification or skin whitening with the image region specified by way of the face detection unit 52 as a target.

The situation judgment unit 54 acquires predetermined judgment information relating to a judgment as to whether being a predetermined situation in which the person who is the photographer should exist within a photographed range.

In a case in which it is judged as a predetermined situation in which a person who is a photographer should exist within a photographed range based on the predetermined judgment information acquired by the situation judgment unit 54, the skin beautification/skin whitening processing unit 55 controls to execute region specification processing which preferentially performs a characteristic detection relating to a color of a person over a characteristic detection relating to the form of a person by a region specification unit, and execute the image processing relating to skin beautification or skin whitening on the image region specified by the region specification processing.

With such a configuration, in the image capture apparatus 1, in a case in which it is judged as being a predetermined situation in which the person who is a photographer should exist within a photographed range based on predetermined judgment information acquired by the situation judgment unit 54, it is possible to efficiently control execution of image processing unique to a subject on a subject within a photographed image in order to execute region specification processing which preferentially performs a characteristic detection relating to the color of a person over a characteristic detection relating to the form of a person by a region specification unit.

It should be noted that the present invention is not to be limited to the aforementioned embodiments, and that modifications, improvements, etc. within a scope that can achieve the objects of the present invention are also included in the present invention.

In the abovementioned embodiment, although it is configured to include a single image capture unit 16 so as to judge a situation in which photographing oneself is performed (setting the selfie mode in the present embodiment), for example, it may be configured to judge a situation of having switched to an image capture unit for selfie upon configuring the image capture apparatus 1 so as to include both an image capture unit for selfie and another image capture unit, or it may be configured to judge a situation of a positional relationship having been arranged which is estimated that selfie can be performed in a case in which either an image capture unit or a monitor, or both in the image capture unit 1 is (are) configured so as to be movable in terms of angle and direction.

Furthermore, in the abovementioned embodiment, although the situation of performing selfie as the situation in which the face of a person should be included, the present invention is not limited thereto. For example, in a case in which a face was detected in a live view image, etc., in a state immediately before photography, since it is highly likely that a face is included even when a face was not detected at the time of photography, it may be configured so as to define as the situation in which the face of a person should be included. Furthermore, since the face is close to a hair region, it may be configured so as to define as the situation in which the face of a person should be included by judging a relationship between, a skin color region and a hair region which is brown, black, etc., and located side by side with the skin color region. Furthermore, it may be configured so as to define as the situation in which the face of a person should be included in case of a result of the face detection not having satisfied, but being close to a certain reference (for example, a case in which a facial part does not suit a certain reference, etc.). More specifically, in a case of the second viewpoint being set as low-accuracy face detection, it can be configured so that the accuracy of specifying an image region corresponding to a predetermined subject is lower than a case of the first viewpoint being set as high-accuracy face detection, but the probability of being capable of specifying an image region as a target for the first image processing is high.

Furthermore, although the skin beautification processing which changes a surface texture to make a facial skin color preferable and/or the skin whitening processing which makes the skin color to be white, which is said to be beautiful, are performed in the abovementioned embodiment, it may be configured so as to perform processing to make not only the skin, but also another object preferable, for example.

Furthermore, in the abovementioned embodiment, it may be configured so as to build in another substitute function in place of the face detection to an image capture apparatus without the face detection function.

Furthermore, although it is configured so as to perform the skin beautification/skin whitening on the facial skin of a person in the abovementioned embodiment, it may be configured so as to perform the skin beautification/skin whitening on the skin of a person, a mouth, and the like. Furthermore, the target is not limited to a person, and it may also be configured to perform processing of making the color of a photographed image of a subject itself look not just normal as it is, but more beautiful or vivid. More specifically, a target may be an apple (vivid red, smooth surface, gloss with shiny appearance) or a mountain (vivid green). In such a case, such processing is performed by judging a mode, an instruction, and the like regarding a situation in which a subject as a target should be included.

In the aforementioned embodiments, explanations are provided with the example of the image capture apparatus 1 to which the present invention is applied being a digital camera; however, the present invention is not limited thereto in particular.

For example, the present invention can be applied to any electronic device in general having a photography processing function. More specifically, for example, the present invention can be applied to a laptop personal computer, a television receiver, a video camera, a portable navigation device, a cell phone device, a smartphone, a portable gaming device, and the like.

The processing sequence described above can be executed by hardware, and can also be executed by software.

In other words, the hardware configurations of FIG. 2 are merely illustrative examples, and the present invention is not particularly limited thereto. More specifically, the types of functional blocks employed to realize the above-described functions are not particularly limited to the examples shown in FIG. 2, so long as the image capture apparatus 1 can be provided with the functions enabling the aforementioned processing sequence to be executed in its entirety.

A single functional block may be configured by a single piece of hardware, a single installation of software, or a combination thereof.

In a case in which the processing sequence is executed by software, the program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM 12 of FIG. 1 in which the program is recorded or a hard disk, etc. included in the storage unit 19 of FIG. 1.

It should be noted that, in the present specification, the steps defining the program recorded in the storage medium include not only the processing executed in a time series following this order, but also processing executed in parallel or individually, which is not necessarily executed in a time series.

In this way, configurations such as how the plurality of functions (processing, unit) necessary for acquiring a variety of the abovementioned effects is divided, whether or not each function thus divided is realized by hardware or software, and the like are arbitrary. Other configuration examples are described below.

### Aspect 1

A configuration is established so as to include: an image capture apparatus including an image capture unit including an image sensor and a control unit including a CPU,
wherein the control unit detects a facial portion of a person within an image captured by the image capture unit and performs image processing unique to a person on the facial portion,
and, in a case in which it is possible to estimate that a person is a target for photographing by a method different from detection of a face of the person, the control unit controls to perform the image processing unique to a person on a skin color portion detected within the image.

### Aspect 2

A configuration is established further to the abovementioned configuration in which,
in a case in which a facial portion of a person could be detected within the image, the control unit performs the image processing unique to a person on the facial portion, and in a case in which a facial portion of a person could not be detected within the image and it is possible to estimate that a person is a target for photographing by a method different from detection of a face of the person, the control unit performs the image processing unique to a person on a skin color portion within the image.

### Aspect 3

A configuration is established further to the abovementioned configuration in which,
under the condition in which a facial portion of a person could be detected within the image, it is selectable between an operation mode of performing the image processing unique to a person on the facial portion, and, under the condition in which it is possible to estimate that a person is a target for photographing by a method different from detection of a face of the person, it is possible to choose an operation mode of performing the image processing unique to a person on a skin color portion within the image.

### Aspect 4

A configuration is established further to the abovementioned configuration in which
the image processing unique to a person is processing of changing a skin color or a skin condition of a person.

### Aspect 5

A configuration is established further to the abovementioned configuration in which
the method different from detection of a face of the person in order to estimate that a person is a target for photographing is a method of estimating that a person is a target for photographing in a case in which a photographing mode with a person as a target for photographing being set.

### Aspect 6

A configuration is established so as to include: an image capture apparatus comprising an image capture unit including an image sensor and a control unit including a CPU,
in which the control unit detects a subject using characteristic information of a first viewpoint relating to a subject of a specific kind within an image captured by the image capture unit and performs image processing unique to the subject on a subject portion detected,
and, in a case in which it is possible to estimate that the subject of the specific kind is a target for photographing using other information different from characteristic information relating to the subject of the specific kind, the control unit controls so as to perform image processing unique to the subject of the specific kind on an image region detected using characteristic information of a second viewpoint relating to the subject of the specific kind.

### Aspect 7

A configuration is established further to the abovementioned configuration in which,
in a case in which the subject of the specific kind could be detected within the image, the control unit performs the image processing unique to the subject on a subject portion detected, and in a case in which the subject of the specific kind could not be detected within the image and it is possible to estimate that the subject of the specific kind is a target for photographing using other information different from characteristic information relating to the subject of the specific kind, the control unit performs the image processing unique to the subject of the specific kind on an image region detected using the characteristic information of the second viewpoint relating to the subject of the specific kind.

### Aspect 8

A configuration is established further to the abovementioned configuration in which,
under the condition in which the subject of the specific kind could be detected within the image, it is possible to choose an operation mode of performing the image processing unique to the subject on a subject portion detected, and, under the condition in which it is possible to estimate that the subject of the specific kind is a target for photographing using other information different from characteristic information relating to the subject of the specific kind, it is possible to choose an operation mode of performing the image processing unique to the subject of the specific kind on an image region detected using the characteristic information of the second viewpoint relating to the subject of the specific kind.

### Aspect 9

A configuration is established further to the abovementioned configuration in which,
regarding the detection using the characteristic information of the second viewpoint as compared with the detection using the characteristic information of the first viewpoint, a possibility of erroneously detecting an image region which is not an image region corresponding to the subject of the specific kind but the probability of not being detected is high, while a probability of an image region corresponding to the subject of the specific kind being included is low.

### Aspect 10

A configuration is established further to the abovementioned configuration in which,
in the detection using the characteristic information of the first viewpoint, judging whether the subject of the specific kind exists within an image is performed, and,
in the detection using the characteristic information of the second viewpoint, only specifying an image region on which to conduct the image processing is performed without performing judging of whether the subject of the specific kind exists within an image.

### Aspect 11

A configuration is established further to the abovementioned configuration in which,
the characteristic information of the first viewpoint includes a characteristic of a form of the subject of the specific kind, or a characteristic of a positional relationship of a plurality of portions constituting the subject, and
the characteristic information of the second viewpoint does not include the characteristic of the form or the characteristic of the positional relationship, and includes a characteristic of a color of the subject of the specific kind.

### Aspect 12

A configuration is established further to the abovementioned configuration in which,
the subject of the specific kind is a person,
the characteristic information of the first viewpoint includes a characteristic of a form of the face of a person or a characteristic of a positional relationship of a plurality of portions constituting the face of a person, and
the characteristic information of the second viewpoint does not include the characteristic of the form or the characteristic of the positional relationship, and includes a characteristic of a skin color of a person.

### Aspect 13

A configuration is established further to the abovementioned configuration in which
the image processing unique to the subject of the specific kind is processing of changing a skin color or a skin condition of a person.

### Aspect 14

A configuration is established further to the abovementioned configuration in which,
in a case in which a selfie mode for photographing oneself is set, the control unit specifies an image region by prioritizing detection using the characteristic information relating to the skin color, over detection using the characteristic information relating to the form or the positional relationship.

### Aspect 15

A configuration is established further to the abovementioned configuration in which,
in a case in which a selfie mode for photographing oneself is set, the control unit specifies an image region by prioritizing detection using the characteristic information relating to the form or the positional relationship, over detection using the characteristic information relating to the skin color.

### Aspect 16

A configuration is established further to the abovementioned configuration in which,
in a case of detecting an image region corresponding to a person in order to adjust a photographing condition to a person, the control unit does not perform detection using the characteristic information of the second viewpoint, and performs detecting using the characteristic information of the first viewpoint.

### Aspect 17

A configuration is established further to the abovementioned configuration in which,
in a case of detecting an image region corresponding to a person in order to adjust a focus to a distance to a person or to adjust an exposure condition to brightness of a person, the control unit does not perform detection using the characteristic information of the second viewpoint, and performs detecting using the characteristic information of the first viewpoint.

### Aspect 18

A configuration is established so as to include: an image capture unit;
a first region specification unit that specifies an image region corresponding to a predetermined subject within a photographed image captured by the image capture unit using characteristic information of a first viewpoint relating to the subject;
a second region specification unit that specifies an image region within the photographed image using characteristic information of a second viewpoint different from the first viewpoint relating to the predetermined subject;
an image processing unit that executes predetermined image processing with the image region corresponding to the predetermined subject as a target; and,
a control unit that executes image processing with an image region specified by the second region specification unit as a target, in a case in which the image processing executed by the image processing unit is first image processing unique to the predetermined subject.

### Aspect 19

A configuration is established so that, in a case in which the first region specification unit could not specify an image region corresponding to the predetermined subject, the control unit causes the image processing unit to execute the first image processing with an image region specified by the second region specification unit as a target.

### Aspect 20

A configuration is established further to the abovementioned configuration in which,
for the second region specification unit as compared with the first region specification unit, the accuracy of specifying an image region corresponding to the predetermined subject is lower than that of the first region specification unit, while the probability that an image region as a target for the first image processing can be specified is higher than that of the first region specification unit.

### Aspect 21

A configuration is established further to the abovementioned configuration in which,
in a case in which the image processing executed by the image processing unit is second image processing, the control unit executes the image processing with an image region specified by the first region specification unit as a target.

### Aspect 22

A configuration is established further to the abovementioned configuration to include:
a first judgment unit that judges whether being a situation in which the predetermined subject should exist within a photographed range without using characteristic information relating to the predetermined subject,
in which, under the condition in which it has been judged by the first judgment unit as being a situation in which the predetermined subject should exist within a photographed range, the control unit causes the image processing unit to execute the first image processing with an image region specified by the first region specification unit as a target.

### Aspect 23

A configuration is established further to the abovementioned configuration so that,
under the condition in which it has been judged by the first region specification unit that an image region corresponding to the predetermined subject could not be specified and it was a situation in which the predetermined subject should exist within a photographed range, the control unit causes the image processing unit to execute the first image processing with an image region specified by the first region specification unit as a target.

### Aspect 24

A configuration is established further to the abovementioned configuration so that
the first region specification unit performs both judging whether the predetermined subject exists within a photographed range and specifying an image region on which the image processing unit executes image processing, and
the second region specification unit only performs specifying an image region on which the image processing unit executes image processing without performing judging whether the predetermined subject exists within a photographed range.

### Aspect 25

A configuration is established further to the abovementioned configuration so as to cause the image processing unit to execute the first image processing with an image region specified by the first region specification unit as a target,
in a case in which it has not been judged by the first judgment unit as being a situation in which the predetermined subject should exist within a photographed range, under the condition in which it has been judged by the first region specification unit that the predetermined subject exists within a photographed range.

### Aspect 26

A configuration is established further to the abovementioned configuration so that
the control unit controls execution of image processing by the image processing unit according to a region specification result by the first region specification unit or the second region specification unit and a judgment result by the first judgment unit.

### Aspect 27

A configuration is established further to the abovementioned configuration so that
the control unit selects either the first region specification unit or the second region specification unit for specifying an image region as a target for image processing unique to the predetermined subject by the image processing unit according to a judgment result of the first judgment unit.

### Aspect 28

A configuration is established further to the abovementioned configuration so that
the characteristic information of the first viewpoint is a characteristic of a form of the predetermined subject,
the characteristic information of the second viewpoint is a characteristic of a color of the predetermined subject,
the first region specification unit specifies the image region using at least the characteristic of a form of the predetermined subject, and
the second region specification unit specifies the image region without using the characteristic of a form of the predetermined subject.

### Aspect 29

A configuration is established further to the abovementioned configuration so that
the first region specification unit specifies the image region using both the characteristic of the form and the characteristic of the color of the predetermined subject, and
the second region specification unit specifies the image region using only the characteristic of the color of the predetermined subject.

### Aspect 30

A configuration is established further to the abovementioned configuration so that
the predetermined subject is a person,
the first region specification unit specifies an image region corresponding to the face of a person within a photographed image captured by the image capture unit by face detection processing using characteristic information of the face of a person, and
the second region specification unit specifies an image region on which image processing unique to a person is executed without performing the face detection processing.

### Aspect 31

A configuration is established further to the abovementioned configuration so as to further include:
a second judgment unit that judges whether being a situation in which the face of a person should exist within a photographed range without using a detection result of a face by the face detection processing.

### Aspect 32

A configuration is established further to the abovementioned configuration so that
the second region specification unit specifies an image region having a color corresponding to a skin color of a person as an image region on which the image processing unique to the person is executed without performing the face detection processing.

### Aspect 33

A configuration is established further to the abovementioned configuration so that
the image processing unit executes image processing relating to skin beautification or skin whitening, as the first image processing, with an image region corresponding to the skin of a person as a target.

### Aspect 34

A configuration is established further to the abovementioned configuration so that
the image processing unit executes image processing to adjust a photographing condition to a person, as the second image processing, with an image region corresponding to a person as a target.

### Aspect 35

A configuration is established further to the abovementioned configuration so that
the second image processing is image processing to adjust a focus to a distance to a person or image processing to adjust an exposure condition to brightness of a person.

### Aspect 36

A configuration is established to include: an image capture unit;
a region specification unit that executes region specification processing to specify an image region corresponding to a skin portion of a person within a photographed image captured by the image capture unit;
an image processing unit that executes image processing relating to skin beautification or skin whitening with an image region specified by the region specification unit as a target;
an acquisition unit that acquires predetermined judgment information relating to a judgment whether being a predetermined situation in which a person as a photographer should exist within a photographed range; and
a control unit that, in a case in which it is judged as a predetermined situation in which a person who is the photographer should exist within a photographed range based on the predetermined judgment information acquired by the acquisition unit, controls to execute region specification processing which preferentially performs a characteristic detection relating to a color of a person over a characteristic detection relating to a form of a person by the region specification unit, and execute the image processing relating to skin beautification or skin whitening by the image processing unit on the image region specified by the region specification processing.

What is claimed is:

1. An image capture apparatus comprising an image capture unit including an image sensor and a control unit including a CPU,
wherein the control unit detects a facial portion of a person within an image captured by the image capture unit and performs image processing unique to a person on the facial portion,
and, in a case in which it is possible to estimate that a person is a target for photographing by a method different from detection of a face of the person, the control unit controls to perform the image processing unique to a person on a skin color portion detected within the image.

2. The image capture apparatus according to claim 1,
wherein, in a case in which a facial portion of a person could be detected within the image, the control unit performs the image processing unique to a person on the facial portion, and in a case in which a facial portion of a person could not be detected within the image and it is possible to estimate that a person is a target for photographing by a method different from detection of a face of the person, the control unit performs the image processing unique to a person on a skin color portion within the image.

3. The image capture apparatus according to claim 1,
wherein, under the condition in which a facial portion of a person could be detected within the image, it is selectable between an operation mode of performing the image processing unique to a person on the facial portion, and, under the condition in which it is possible to estimate that a person is a target for photographing by a method different from detection of a face of the person, it is possible to choose an operation mode of performing the image processing unique to a person on a skin color portion within the image.

4. The image capture apparatus according to claim 1,
wherein the image processing unique to a person is processing of changing a skin color or a skin condition of a person.

5. The image capture apparatus according to claim 1,
wherein the method different from detection of a face of the person in order to estimate that a person is a target for photographing is a method of estimating that a person is a target for photographing in a case in which a photographing mode with a person as a target for photographing being set.

6. An image capture apparatus comprising an image capture unit including an image sensor and a control unit including a CPU,
wherein the control unit detects a subject using characteristic information of a first viewpoint relating to a subject of a specific kind within an image captured by the image capture unit and performs image processing unique to the subject on a subject portion detected,
and, in a case in which it is possible to estimate that the subject of the specific kind is a target for photographing using other information different from characteristic information relating to the subject of the specific kind, the control unit controls so as to perform image processing unique to the subject of the specific kind on an image region detected using characteristic information of a second viewpoint relating to the subject of the specific kind.

7. The image capture apparatus according to claim 6,
wherein, in a case in which the subject of the specific kind could be detected within the image, the control unit performs the image processing unique to the subject on a subject portion detected, and in a case in which the subject of the specific kind could not be detected within the image and it is possible to estimate that the subject of the specific kind is a target for photographing using other information different from characteristic information relating to the subject of the specific kind, the control unit performs the image processing unique to the subject of the specific kind on an image region detected using the characteristic information of the second viewpoint relating to the subject of the specific kind.

8. The image capture apparatus according to claim 6,
wherein, under the condition in which the subject of the specific kind could be detected within the image, it is possible to choose an operation mode of performing the image processing unique to the subject on a subject portion detected, and, under the condition in which it is possible to estimate that the subject of the specific kind is a target for photographing using other information different from characteristic information relating to the subject of the specific kind, it is possible to choose an operation mode of performing the image processing unique to the subject of the specific kind on an image region detected using the characteristic information of the second viewpoint relating to the subject of the specific kind.

9. The image capture apparatus according to claim 6,
wherein, regarding the detection using the characteristic information of the second viewpoint as compared with the detection using the characteristic information of the first viewpoint, a possibility of erroneously detecting an image region which is not an image region corresponding to the subject of the specific kind but the probability of not being detected is high, while a probability of an image region corresponding to the subject of the specific kind being included is low.

10. The image capture apparatus according to claim 6,
wherein, in the detection using the characteristic information of the first viewpoint, judging whether the subject of the specific kind exists within an image is performed, and,
in the detection using the characteristic information of the second viewpoint, only specifying an image region on which to conduct the image processing is performed without performing judging of whether the subject of the specific kind exists within an image.

11. The image capture apparatus according to claim 6,
wherein the characteristic information of the first viewpoint includes a characteristic of a form of the subject of the specific kind, or a characteristic of a positional relationship of a plurality of portions constituting the subject, and
the characteristic information of the second viewpoint does not include the characteristic of the form or the characteristic of the positional relationship, and includes a characteristic of a color of the subject of the specific kind.

12. The image capture apparatus according to claim 6,
wherein the subject of the specific kind is a person,
wherein the characteristic information of the first viewpoint includes a characteristic of a form of the face of a person or a characteristic of a positional relationship of a plurality of portions constituting the face of a person, and
wherein the characteristic information of the second viewpoint does not include the characteristic of the form or the characteristic of the positional relationship, and includes a characteristic of a skin color of a person.

13. The image capture apparatus according to claim 12,
wherein the image processing unique to the subject of the specific kind is processing of changing a skin color or a skin condition of a person.

14. The image capture apparatus according to claim 12,
wherein, in a case in which a selfie mode for photographing oneself is set, the control unit specifies an image region by prioritizing detection using the characteristic information relating to the skin color, over detection using the characteristic information relating to the form or the positional relationship.

15. The image capture apparatus according to claim 14,
wherein, in a case in which a selfie mode for photographing oneself is set, the control unit specifies an image region by prioritizing detection using the characteristic information relating to the form or the positional relationship, over detection using the characteristic information relating to the skin color.

16. The image capture apparatus according to claim 12,
wherein, in a case of detecting an image region corresponding to a person in order to adjust a photographing condition to a person, the control unit does not perform detection using the characteristic information of the second viewpoint, and performs detecting using the characteristic information of the first viewpoint.

17. The image capture apparatus according to claim 16,
wherein, in a case of detecting an image region corresponding to a person in order to adjust a focus to a distance to a person or to adjust an exposure condition to brightness of a person, the control unit does not perform detection using the characteristic information of the second viewpoint, and performs detecting using the characteristic information of the first viewpoint.

18. An image capture control method executed by an image capture apparatus including an image capture unit, the method comprising:
detecting a subject using characteristic information of a first viewpoint relating to a subject of a specific kind within an image captured by the image capture unit, and performing image processing unique to the subject on a subject portion detected; and
controlling, in a case in which it is possible to estimate that the subject of the specific kind is a target for photographing using other information different from characteristic information relating to the subject of the specific kind, so as to perform image processing unique to the subject of the specific kind on an image region detected using characteristic information of a second viewpoint relating to the subject of the specific kind.

19. A non-transitory storage medium encoded with a computer-readable program that enables a computer which controls an image capture apparatus including an image capture unit to execute functions of:
detecting a subject using characteristic information of a first viewpoint relating to a subject of a specific kind within an image captured by the image capture unit and performs image processing unique to the subject on a subject portion detected; and
controlling, in a case in which it is possible to estimate that the subject of the specific kind is a target for photographing using other information different from characteristic information relating to the subject of the specific kind, so as to perform image processing unique to the subject of the specific kind on an image region detected using characteristic information of a second viewpoint relating to the subject of the specific kind.
